(19) United States
(12) Patent Application Publication
(10) Pub. No.: US 2007/0218793 A1
(43) Pub. Date: Sep. 20, 2007

(54) Laminated Fabric for Sail of Wind-Driven Engines

(75) Inventor: Pascal Rossignol, Najac (FR)

Correspondence Address: YOUNG & THOMPSON, 745 SOUTH 23RD STREET, 2ND FLOOR, ARLINGTON, VA, 22202, US

(73) Assignee: Custom-Laminates-Manufacturing, Najac (FR)

(21) Appl. No.: 11/547,778

(22) PCT Filed: Apr. 8, 2005
(86) PCT No.: PCT/FR05/00860

§ 371 Date: Feb. 6, 2007

(30) Foreign Application Priority Data
Apr. 9, 2004 (FR) 0403787

(51) Int. Cl. B32B 27/12

(52) U.S. Cl. 442/76; 428/190

(57) ABSTRACT

A canvas with a laminated structure which is designed for the production of sails for wind-driven craft, has a core (250) which includes each sealing leaf of the canvas, and at least two layers (203, 205) of structural fibres (503, 505) which all extend on the exterior of the core (250), with at least one layer (203, 205) on each side of the core (250). In the canvas, each sealing leaf includes at least one continuous film (220) of polymer material, and the structural fibres serve the purpose of reinforcing the resistance of the canvas in relation to mechanical loads which can be applied to the canvas. The invention also extends to sails which are at least partially produced from a material of this type.

The invention relates to a canvas with a laminated structure which is designed for the production of sails for wind-driven craft. The invention also extends to sails which are at least partly made of a material of this type.

The performance of wind-driven craft, in particular sailing boats, cruise boats and boats for racing on the high seas, depends to a large extent on the design of their sails, both at the level of the materials used and that of their structure (overall geometry and geometry of the different panels or cloths).

Three-dimensional sails consist either of assemblies of a plurality of panels (or cloths), or of a single panel, which may optionally be moulded.

The panel(s) of modern sails, which are acknowledged as having the highest performance levels, is/are generally made from a material with a laminated structure in the general form of a sheet which is more or less thick, consisting of one or a plurality of layers of fibres interposed between flexible leaves of continuous polymer material. A canvas structure of this type, as described for example by EP 1 114 771, EP 0 885 803, U.S. Pat. No. 6,112,689 and U.S. Pat. No. 5,001,003, is known as a “sandwich” form.

Throughout the text, a material of this type which constitutes a panel of the sail is designated by the term “canvas”, even if it is not formed by a fabric.

Similarly, throughout the text, the term “fibre” can designate equally well a thread or cable made of natural or synthetic material, in particular twisted fibrous material, or a strip or band of woven or non-woven material.

The flexible leaves of continuous polymer material (free from holes) serve the main purpose of providing the sail with a certain property of sealing against air. Each of these leaves, known as sealing leaves, can be formed by a single film or superimposition of films. In general these are continuous films made of thermoplastic material, in particular of polyethylene terephthalate (PET), a material which is better known by the brand name of MYLAR® (DUPONT DE NEMOURS, United States).

The fibres used in this type of material, in this case canvases, with a sandwich structure, can be distributed in two groups according to the main function which they fulfil within the material.

The so-called structural, woven or non-woven fibres define the core of the canvas. They are distributed in a non-homogeneous manner throughout the canvas. In general, their orientation is determined to coincide as far as possible with the lines of the main stresses which develop in the sail during its use, and their density increases in the parts of the sail which are the most exposed to mechanical stresses. These structural fibres therefore have the main function of providing the sail with good resistance to the mechanical stresses which are normally applied to a sail when it is functioning.

Optionally, the continuous films of polymer material which form the sealing leaves can be covered with a grid or taffeta of woven fibres glued to at least one of their surfaces. The main function of these warp and weft fibres which form the said grid or taffeta is not to reinforce the resistance of the sail to the mechanical loads which may be applied to it, but to improve in an isotropic manner certain of the physical and mechanical properties of the film of polymer material with which they are specifically associated. These fibres, which are distributed relatively homogeneously over all of the surface of a continuous film of polymer material, for example in order to improve the resistance to wear and/or the service life of the film, and consequently of the sail, can therefore be distinguished from the so-called structural fibres. In the remainder of the text, these will be designated by the term of “secondary fibres”.

These materials with a sandwich structure form the basis of the best performing sails which are on the market at present. However, it is known that the performance of a sail canvas, in particular for nautical sails, depends mainly on the dimensional stability of the material, its levelness, and its low weight. In the case of a canvas with a sandwich structure, the control and optimisation of these parameters are particularly problematic.

In fact, the structural fibres have a non-zero thickness and have distribution which is not homogeneous throughout the extent of the canvas. Moreover, the core of a canvas with a sandwich structure has many rough parts which disrupt the levelness of the final canvas. At the expense of the lightness of the material, it has been proposed to counter-glue the structural fibres between two sealing leaves, with a layer of glue which is thick enough to be able to fill the spaces and hollows which are present between the fibres. In addition to a loss of lightness, it is also found that there is an increase in the elongation under load and a loss of flexibility of the canvas.

Also, in particular when the counter-gluing is carried out in hot conditions, it is a delicate operation which disrupts the original mechanical properties of the structural fibres, and substantially induces shrinkage. The counter-gluing leads to the appearance of significant tensions between the structural fibres, between the structural fibres and the films of polymer material, and finally between the sealing leaves. These tensions give rise to mutual distortions of the sealing leaves, reduce their mechanical performance, and affect the levelness of the canvas.

The object of the invention is to eliminate these different disadvantages by proposing canvases which have a structure which is different from a so-called sandwich structure, and which, whilst having a particularly simple design, can have simultaneously the following advantages:
that of being able to be produced more simply and economically, with structural fibres and sealing leaves which may be of the same nature as that of the structural fibres and sealing leaves used for the production of the known canvases with a sandwich structure; and
that of having characteristics, in particular of dimensional stability, levelness and lightness, which are at least similar to, or better than, those of the known canvases with a sandwich structure.

In particular, the object of the invention is to propose a canvas with a particular structure, the design of which permits easy control of its dimensional stability, levelness and weight, and allows many prospects of optimisation of these parameters.

For this purpose, the invention relates to a canvas for sails of wind-driven craft, which has a laminated structure and consists of an assembly comprising:
at least one leaf, known as a sealing leaf, which is flexible and provides the said canvas with properties of sealing against air; the said sealing leaf comprising at least one continuous film of polymer material; and
at least one layer of fibres, known as structural fibres, which serve the purpose of reinforcing the resistance of the said canvas to mechanical loads which may be applied to part of a sail produced using the said canvas.

According to the invention, said canvas has:
a core which comprises each sealing leaf of the said canvas; and
at least two layers of structural fibres which all extend on the exterior of the core, with at least one layer on each side of the core.

Thus, the core of the said canvas which is interposed between layers of structural fibres is itself free from any layer of structural fibres between the sealing leaves.

Thus, when a canvas according to the invention comprises only a single sealing leaf, this sealing leaf forms the core of the canvas. On the other hand, when a canvas according to the invention comprises a plurality of sealing leaves, the opposite outer surfaces of the outermost sealing leaves of the canvas delimit the core of this canvas.

A canvas according to the invention is thus distinguished from the structural canvases in so-called sandwich form, in that the structural fibres are not counter-glued between two continuous films of polymer material which constitute sealing leaves, but are added onto the surfaces of a single sealing leaf, or onto the peripheral surface of the outermost sealing leaves of the core of a canvas according to the invention. Consequently, the invention makes it possible to dispense with the disadvantages encountered with counter-gluing of structural fibres between two sealing leaves, and in particular two continuous films of polymer material.

In a canvas according to the invention, the structural fibres have in particular the advantage of being able to be associated with the sealing leaf with a minimal thickness of glue, thus saving weight and increasing flexibility.

The inventor has also found that the arrangement of the structural fibres on the outer surfaces of the canvas permits improved maintenance of their original properties, and in particular mechanical and physical properties, and thus makes it possible to reduce contraction and the phenomena of shrinkage.

In addition, with a canvas structure of this type, the invention makes it possible to increase advantageously the proportion of structural fibres in relation to the quantity of material which acts as a sealing leaf, and to the quantity of adhesive composition previously used, thus providing canvases and sails with improved dimensional stability and improved resistance to elongation under load, for a relatively negligible increase in weight.

A canvas structure as defined by the invention can give rise to many optimisations, in particular by means of an appropriate choice of materials which constitute the sealing leaves, the structural fibres, the secondary fibres, the adhesive compositions used, etc., as well as by means of particular determination of the distribution of the structural and secondary fibres.

Thus, advantageously, in a canvas according to the invention, the continuous film(s) of polymer material which constitute(s) a sealing leaf is/are advantageously of the polyester, polyamide, polyurethane or polyethylene type. Preferably, terephthalate polyethylene or naphthalate polyethylene is involved.

Also, advantageously and according to the invention, in a canvas according to the invention, the structural fibres are non-woven and are formed by a material selected from amongst: a polyester, a polyamide and an aramid. Preferably, advantageously, fibres are selected from amongst fibres of polyethylene, carbon, polybenzoxazole (PBO), naphthalate polyethylene and terephthalate polyethylene.

Advantageously, and according to the invention, multi-filaments are involved, comprising in particular approximately 100-2000 units. In addition, it is advantageous to control the twisting of these structural fibres, in order to control the internal wetting of the multi-filaments during the coating (in particular by an adhesive composition) under tension, in order subsequently to glue them flat onto the flat surface of a sealing leaf.

The dimensional stability and the modulus of global elasticity of the material will be all the greater, the more the filaments which compose each fibre are glued to one another within this same fibre, and also to the other fibres which are juxtaposed or superimposed.

The parameters of cross-section, twisting, oiling, tension, etc, relating to the fibres, can be adapted according to the coating required and independently for each sail canvas and for each sail panel canvas. For a canvas with a long service life, for example, preference will be given to polyethylene fibres with a high Young's modulus, with a coating with an adhesive composition which is limited to the periphery of the fibres, without gluing of the central filaments of each fibre. Thus, precedence will be given to flexibility and elasticity.

According to a particularly preferred embodiment, the structural fibres of a single layer extend continuously and without overlapping one another through the surface of the canvas, from one end to the other, with orientation which converges radially substantially into one point. According to this particular embodiment, these structural fibres can extend through the canvas in a manner which is straight or more or less curved.

Advantageously, the structural fibres of two distinct layers of a canvas according to the invention have the same orientation which converges radially substantially into one point.

According to a variant embodiment, in a canvas according to the invention, the radially converging structural fibres of two different layers of a canvas according to the invention converge substantially into two different points.

When the structure of the continuous film(s) of polymer material has globally a certain fragility, it may be advantageous to provide them with reinforcement means which permit isotropic improvement of certain of their mechanical and/or physical properties.

For this purpose, advantageously and according to the invention, at least one of the continuous films of polymer material which constitutes the core of the said canvas has at least one surface which is covered by a layer of fibres, known as secondary fibres, the purpose of which is to improve in an isotropic manner certain of the mechanical and physical properties. These secondary fibres cover at least one of the surfaces of the said film with a distribution and density which are at least substantially homogeneous. In particular, these secondary fibres will make it possible to improve the service life of the canvas according to the invention.

Advantageously and according to the invention, each layer of secondary fibres is assembled by being glued onto a surface of at least one continuous film of polymer material.

Advantageously and according to the invention, the secondary fibres are made of non-woven fibres. They can optionally be of the same nature as that of the structural fibres. However, the performance levels required from these fibres are in general very much lower than those required from the structural fibres.

According to a first embodiment of the layers of secondary fibres, advantageously and according to the invention, at least one of the layers of secondary fibres of a canvas according to the invention consists of a grid, a taffeta, or a non-woven continuous or discontinuous layer of fibres.

According to a second advantageous embodiment of the layers of secondary fibres according to the invention, the secondary fibres of at least one of these layers form neither a grid nor a taffeta, but extend substantially concentrically through the said canvas, substantially around a single central point. In the same way as the grid or taffeta structures, these added concentric secondary fibres make it possible to limit the deformations along the bias. As well as making the use of the grids/and or taffetas optional, these secondary fibres which are disposed concentrically do not create any mutual shearing, and make it possible to reduce the overall weight of the canvas.

Advantageously and according to the invention, the density of the secondary fibres decreases going away from the said central point.

Advantageously and according to this same aspect of the invention, in a canvas according to the invention the secondary fibres with two different layers extend substantially concentrically and substantially around two different central points.

Advantageously, a canvas according to the invention comprises at least one layer of secondary fibres which extend substantially concentrically substantially around a central point, and at least one layer of structural fibres which extends with an orientation which substantially converges radially into one point, such that the tangents of the arcs of a circle traced by the secondary fibres form angles substantially of approximately 90° with the structural fibres, at the level of the areas of overlapping between structural fibres and secondary fibres. Advantageously and according to the invention, this layer of secondary fibres and this layer of structural fibres cover a single surface of a continuous film of polymer material, the structural fibres forming the outermost layer.

In addition, according to a particular preferred embodiment of the invention, the core of a canvas according to the invention is formed by a single sealing leaf comprising a single continuous film of polymer material. Optionally, at least one of the surfaces of this continuous film of polymer material is coated, by means of counter-gluing, with a layer of secondary fibres, for example secondary fibres which form a taffeta, a grid, or a non-woven layer of continuous or discontinuous fibres.

According to another particular embodiment of a canvas according to the invention, the core of the canvas is formed by a single sealing leaf constituted by the superimposition of two continuous films of polymer material with a layer of secondary fibres interposed, for example curved secondary fibres which extend concentrically through the canvas and around a central point.

In addition, a canvas according to the invention is advantageously covered at least partly on the exterior with a synthetic composition of a paint type with a function of protection of the sails against wear and/or ageing.

The invention also extends to a sail, in particular for a wind-driven craft, in particular for sailing boats, cruise boats and boats for racing on the high seas, produced with at least one piece of a canvas according to the invention.

Advantageously and according to the invention, the said piece of canvas which constitutes the said sail has structural fibres of a single layer which extend continuously and without mutual overlapping through the surface of the said piece of canvas, from one end to another, with an orientation which is substantially radial and converges into one point. According to this aspect of the invention, this piece of canvas is disposed in the sail such that these structural fibres are substantially oriented towards at least one point of attachment of the sail.

In addition, advantageously and according to the invention, the said piece of canvas which constitutes the said sail has secondary fibres of a single layer which extend substantially concentrically through the said piece of canvas, substantially around a single central point. According to this aspect of the invention, this piece of canvas is disposed in the sail such that the said central point coincides at least substantially with one point of attachment of the sail.

According to a particularly preferred form of production of a sail according to the invention, at least one piece of canvas which constitutes the said sail comprises at least one layer of secondary fibres which extend substantially concentrically and substantially around a central point, and at least one layer of structural fibres which extend with an orientation which converges radially into one point, such that the tangents of the arcs of a circle traced by the secondary fibres form angles substantially of approximately 90° with the structural fibres, at the level of the areas of overlapping between structural fibres and secondary fibres. According to this particular aspect of the invention, this piece of canvas is disposed in the sail such that the said central point defined by the said secondary fibres and the point of convergence of the said structural fibres coincide at least substantially with one point of attachment of the sail.

The invention also relates to a canvas, which in particular is designed for the production of sails for wind-driven craft, in particular sailing boats, as well as to a sail for wind-driven craft, characterised in combination by some or all of the characteristics described previously or hereinafter.

Other objects, characteristics and advantages of the invention will become apparent from the following description which relates to the attached figures, in which:

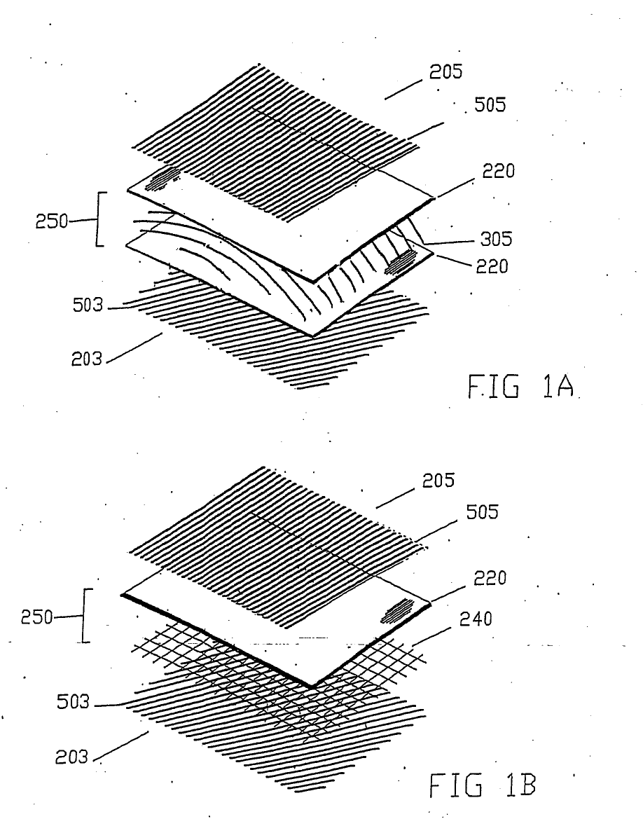

FIGS. 1A and 1B are schematic representations illustrating the particular structure of two embodiments of a canvas according to the invention;

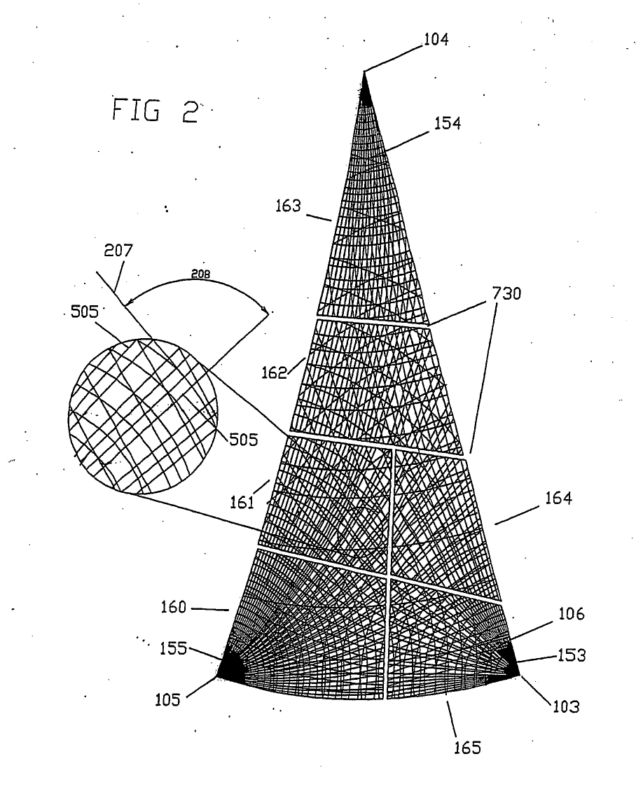

FIG. 2 is a schematic representation of the particular organisation of the structural and secondary fibres of a canvas, according to a particular embodiment of the invention, and of specific use of this canvas for the production of the different panels of a sail of the Genoese type;

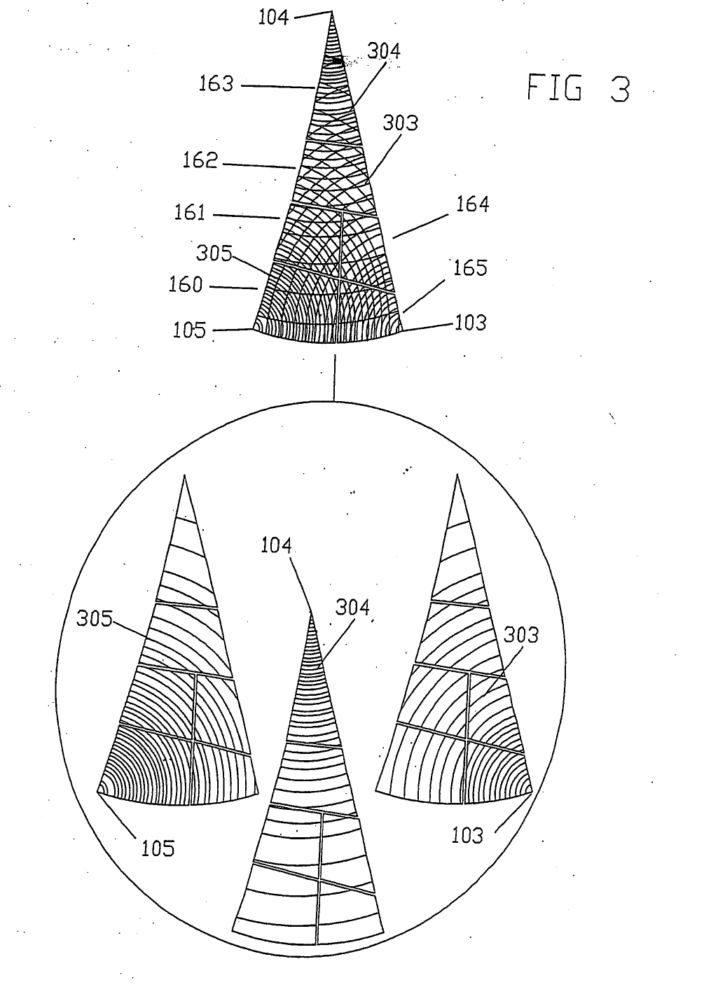

FIG. 3 is a schematic representation illustrating the particular distribution of the secondary fibres of the different pieces of canvas represented in FIG. 2;

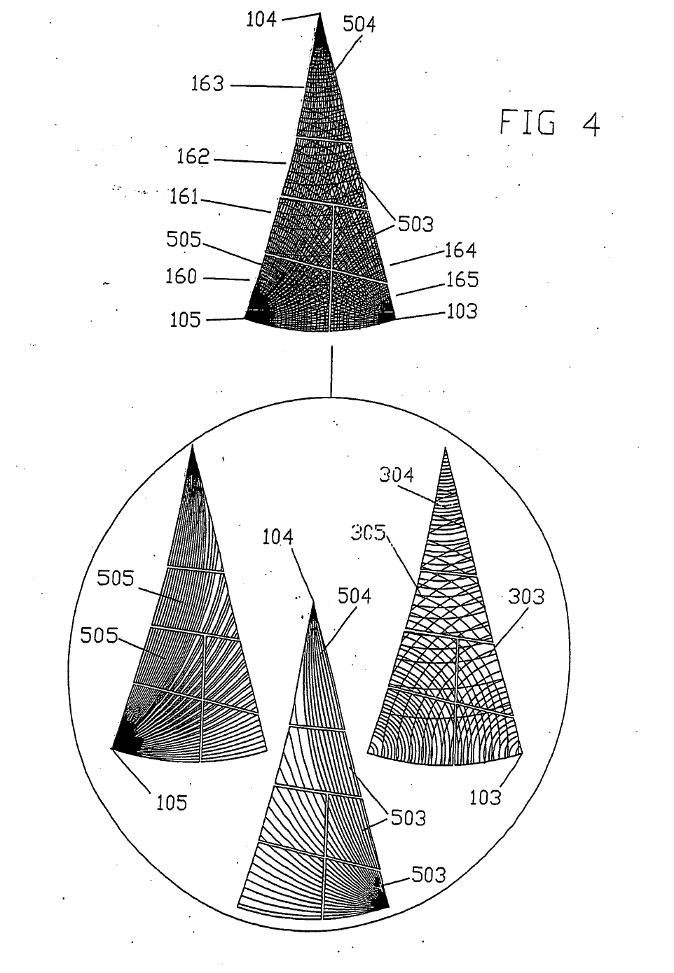

FIG. 4 is a schematic representation illustrating the particular distribution of the structural fibres of the different pieces of canvas represented in FIG. 2;

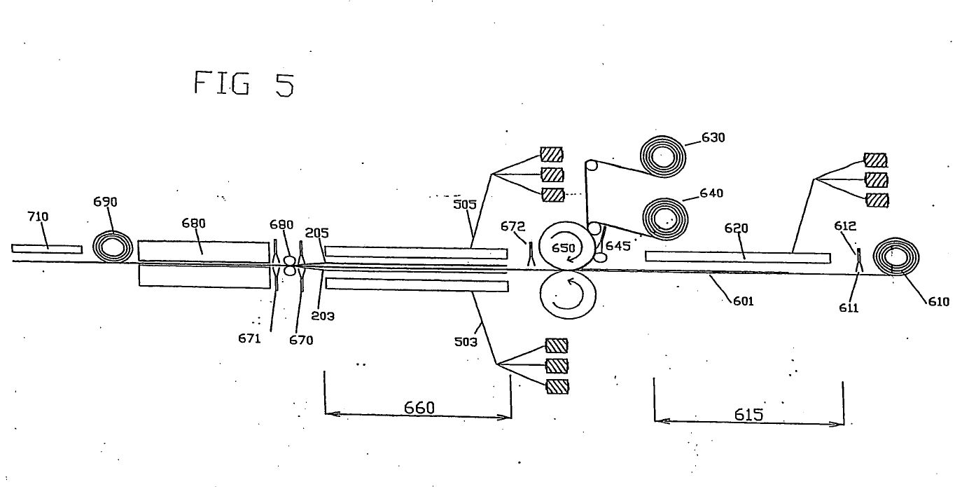

FIG. 5 is a schematic representation of a production chain illustrating different stages of the production of a canvas according to the invention; and

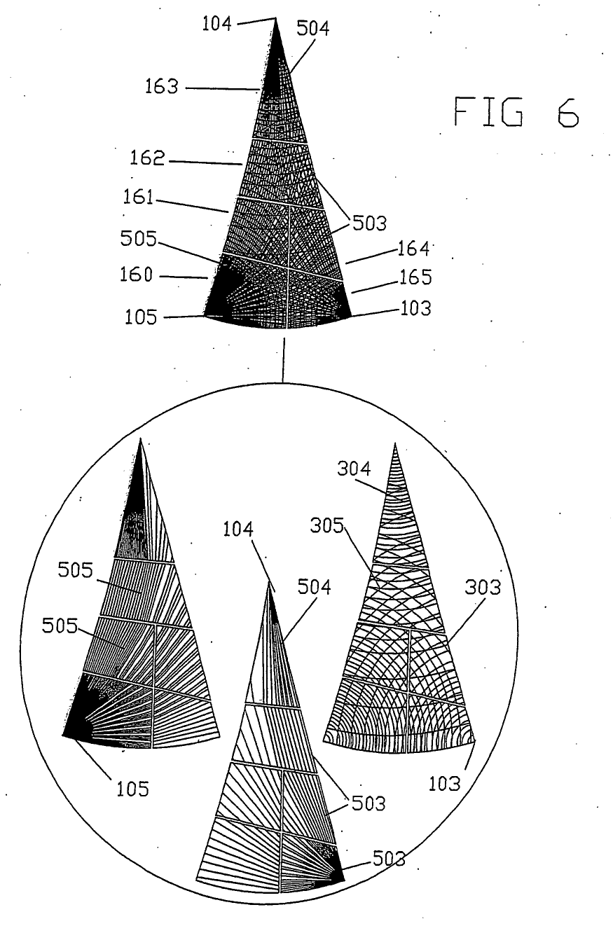

FIG. 6 is a schematic representation illustrating the particular distribution of the structural and secondary fibres of a sail according to the invention, which is different from that of a canvas with the structure represented in FIGS. 2 to 4.

### TWO EMBODIMENTS OF A CANVAS ACCORDING TO THE INVENTION

FIGS. 1A and 1B illustrate two embodiments of a canvas according to the invention. These two embodiments are shown purely by way of non-limiting example of the structure of a canvas according to the invention.

In a first embodiment of the invention, and as illustrated schematically in FIG. 1A, a canvas according to the invention comprises a core 250 constituted by two continuous films 220 of polymer material (for example two films made of polyethylene terephthalate). A layer of secondary fibres 305 is interposed between these two continuous films 220 by counter-gluing.

The combination of the two continuous films 220 made of polymer material with the layer of secondary fibres 305 constitutes the sealing leaf according to the invention. The core 250 of the canvas corresponds to this single sealing leaf.

Layers 503 and 505 of structural fibres 205 are added onto each of the outer surfaces of this sealing leaf by counter-gluing.

The structural fibres 203 and 205 of each of these two layers 503 and 505 are distributed in a manner which is straight through the canvas. The orientation of the structural fibres 505 of the layer 205 is different from that of the structural fibres 503 of the layer 203.

The secondary fibres 305 are curved and are distributed between the two continuous films 220 of the sealing leaf, whilst describing arcs of a circle with substantially the same centre.

In a second embodiment of the invention, and as illustrated schematically in FIG. 1B, a canvas according to the invention consists of a sealing leaf 250 which forms the core of the said canvas. This core consists of a single continuous film 220 of polymer material (for example a polyethylene terephthalate film) which is associated by gluing on one of its two surfaces with a grid 240 (optionally this can be a taffeta with warp and weft fibres) formed by secondary fibres. The association by counter-gluing of the film 220 and the grid 240 forms a sealing leaf according to the invention.

Layers 503 and 505 of structural fibres 205 are added by counter-gluing onto each of the surfaces of this sealing leaf, which alone forms the core 250 of the canvas.

Although they are not shown on the portions of material represented in FIGS. 1A and 1B, the structural fibres 203 and 205 of each of the canvas structures represented advantageously describe together an orientation which substantially converges into one point.

### One Embodiment of a Canvas According to the Invention

FIG. 5 shows an example of a production chain which permits preparation of a canvas with a laminated structure according to the invention. Within this production chain, the canvas which is being formed is displaced in succession to different work stations, in order to be subjected there to different stages of the production process as described hereinafter.

Stage 1: The first stage consists of putting into place the first continuous film of polymer material 601, which is unwound at 610. If it is wished to obtain a canvas comprising a single film, the latter will be unwound under tension at 610, and will reach the station 660 on a flat surface, without intermediate processing.

Stage 2: The film can optionally be reinforced at the station 620 by means of curved secondary fibres 303, 304 and 305. For this purpose, the film 601 is previously coated with a film of adhesive 611 at the station 612.

The secondary fibres are deposited by means of a conventional system 620 (for example similar to those sold in the United States by the companies AUTOMETRIX or CARLSON DESIGN).

Stage 3: Since the curved fibres are now retained by the adhesive film 611, a second film of material can be deposited if necessary. This second film can be based on thermoplastic film, or a woven or non-woven material. It is unwound at 630 and/or at 640, then it is counter-glued at 650 onto the first film 601, after having been previously coated with adhesive at 645 by a gluing system.

Stage 4: The subsequent stage then consists of providing the two layers of structural fibres 503 and 505 under tension at the station 660, on both sides of the sealing leaf 601 which has previously been put into place. These two layers of fibres 203, 205 are produced by means of the device for production of materials with non-parallel continuous fibres, as described in FR 2 817 883. By means of a computer-controlled mechanism, this device makes it possible to deposit under tension two or more layers of fibres, which are retained as far as the subsequent coating stations 670, 680.

If the machine must deposit curved structural fibres 505 or 503, this depositing is carried out on the upper surface which is coated with adhesive at 672 in the same manner as for the depositing of the secondary fibres previously referred to.

Stage 5: At the station 670, the depositing/coating with glue is carried out, and this is following by putting into place under two pressurised rollers at 680.

A synthetic material known as paint can be sprayed at 671. This paint is liquid at the moment when it is applied. It serves the purpose of protection of the finished sail, in particular for the purpose of normal use of the latter. Conventionally this paint can comprise additives which are designed to reducing ageing during exposure in the open air or in a marine environment.

Stage 6: The material is then dried in an oven 690 then wound at 700.

It may be advantageous to provide a tracing and cutting table 710 instead of the station 700, such that each panel can be cut according to the form plan defined by the master sail maker, who will subsequently assemble the panels in order to produce the sail.

If the panels to be produced have a form with a 3-dimensional volume, the following arrangements can be made:

Stage 1: The first layer of material 601 will consist of several rolls of cloth which are unwound at 610, onto a flat surface.

Stage 2: An adhesive film 611 is applied to the sealing leaf at the station 612, then the fibres are deposited by means of a conventional system 620 onto a flat 2-dimensional surface.

Stage 3: No counter-gluing is carried out of a second ply of material at the station 650 in order to keep a sealing leaf de-structured, thus permitting further slight deformation.

Stage 4: The following stage then consists of producing the two layers 203, 205 of straight and/or curved structural fibres 503 and 505, as previously, again on a flat surface.

Stage 5: Coating with glue is carried out at 670, as previously, followed by transfer to the station for putting into place under two pressurised rollers at 680.

Stage 6: When the panel has gone into the drying oven 680, a mould and counter-mould deform the panel whilst the glue is still solvated and flexible. This therefore makes it possible to pre-stress all of the fibres, which improves the future performance and reduces the shrinkage of the material thus produced. Once the material is completely dry, and all the fibres are firmly glued to one another, the mould and counter-mould are released, and the panel can be removed from the oven.

According to a similar principle, it can be envisaged to work at a fixed station. Instead of displacing the material to different stations, the different devices operate at a single station where all the stages of the production process are implemented. This is particularly advantageous for panels or sails with large sizes.

If it is wished to produce panels with a 3-dimensional volume, it is possible to retain the material of the panel by its edges and ends, whilst deforming it by means of a mould and if necessary a counter-mould, at the beginning of the oven drying stage, whilst the glues and/or coating products are fluid or viscous.

Thus, fibres are deposited flat with considerable accuracy in relation to the control of the tensions of the fibres and trajectories, and the deformation carried out at the end of the process will complete the cohesion of the assembly by means of the pre-stressing carried out during the forming.

One Embodiment of Production of a Nautical Sail with a Canvas According to the Invention, having a Particular Laminated Structure.

FIGS. 2, 3 and 4 illustrate the use of a canvas according to the invention, with a particular structure, which is specifically conceived for the design of a high-performance nautical sail.

Conventionally, sails are an assembly of cloths or panels (for example 160 to 165) which are assembled to one another by sewing or gluing of their areas of intersection. These areas of intersection, which are generally approximately 15 to 100 mm wide, are known as overlaps.

The cloths or panels are cut specifically for each canvas, according to a form plan which includes orientation of the cloths or panels and incorporation of darts in order to create a 3-dimensional volume. For this purpose, the sails are computer designed and are woven and/or cut by precision machines.

A sail has attachment points 103 to 106, which permit securing of the sail and its connections to the boat. These attachment points are conventionally the sheet 105, halyard 104 and tack 103, sometimes completed by tack reefs and sheet reefs, a Cuningham 106 and a base reef.

As shown in FIG. 2, a sail according to the invention can advantageously be produced by assembly of panels (or cloths) 160 to 165, which are assembled by gluing or sewing. The different pieces of canvas which constitute these different panels are selected/produced such as to have a particular distribution of structural fibres and secondary fibres, in particular in order to improve the general service life of the sail, as well as its resistance to the mechanical stresses which are exerted on the sail during use.

FIGS. 3 and 4 refer to FIG. 2.

In FIG. 3, the main drawing illustrates only the superimposition of the different layers of secondary fibres of a canvas structure according to the invention; these different layers of secondary fibres are added by counter-gluing onto the surface of at least one continuous film of polymer material. The assembly of these three layers of secondary fibres and of the different continuous film(s) forms one or a plurality of sealing leaves in accordance with the invention. This assembly constitutes the core of the canvas. FIG. 3 thus corresponds to a schematic view of the fibrous organisation of the core of a canvas according to a particular embodiment of the invention.

The secondary drawings illustrate clearly each of these layers and the specific organisation of their secondary fibres.

The secondary fibres of a single layer extend substantially concentrically through the said piece of canvas, around a single central point. Each piece of canvas comprises superimposition of three layers of secondary fibres. Each of these three layers defines a distinct central point (different from those defined by the two other layers), around which the fibres are disposed.

In FIG. 4, the main drawing re-uses that of FIG. 2. Two of the secondary drawings illustrate clearly the two layers of structural fibres which are applied by means of counter-gluing on both sides of the core of the fabric (represented by the third secondary drawing in FIG. 4).

The structural fibres of a single layer extend continuously and without mutual overlapping through the surface of each piece of canvas, from one end to the other. These structural fibres have an orientation which converges radially into one point, and extend through the canvas in a slightly curved manner. The orientation of the structural fibres differs from one layer to another.

The relative distribution of the structural fibres and of the secondary fibres is such that the tangents of the arcs of a circle which are traced by the secondary fibres form angles 208 which are substantially approximately 90° relative to the structural fibres, at the level of the areas of overlapping between structural fibres and secondary fibres (cf FIG. 2).

As shown in FIG. 2, the different pieces of canvas are produced/selected, then assembled into a sail, such that a first layer of structural fibres has curved fibres 505 which are oriented in the direction of the sheet 105 and the halyard 104 of the sail, and the fibres 503 of a second layer of structural fibres are curved and oriented in the direction of the tack 103 and halyard 104 of the sail.

Also, the different pieces of canvas are produced/ selected then assembled into a sail such that the fibres 303, 304 and 305 of the three layers of secondary fibres of the sail are disposed respectively in a manner which is substantially concentric respectively relative to the tack 103, the halyard 104 and the sheet 105 of the sail.

In addition, according to a variant embodiment shown in FIG. 6, the structural fibres 503, 504, 505 are disposed on the sealing leaf in a manner which is straight, and not curved like in FIGS. 2 to 4. In this particular embodiment, in each layer, the structural fibres 503, 504, 505 also advantageously extend without mutual overlapping through the surface of each piece of canvas, from one end to another, with orientation which converges radially substantially into one point.

1. A canvas for wind-driven craft, which has a laminated structure and consists of an assembly comprising:
at least one leaf, known as the sealing leaf, which is flexible and provides the said canvas with properties of sealing against air; the said sealing leaf comprising at least one continuous film (220) of polymer material; and
at least one layer (203; 205) of fibres (503; 504: 505), known as structural fibres, which serve the purpose of reinforcing the resistance of the said canvas to mechanical loads which may be applied to part of a sail produced using the said canvas, wherein the said canvas has:
a core (250) which comprises each sealing leaf of the said canvas; and
at least two layers (203, 205) of structural fibres (503, 505) which all extend on the exterior of the core (250), with at least one layer (203, 205) on each side of the core (250).

2. The canvas as claimed in claim 1, wherein the said continuous film(s) (220) of polymer material which constitute a sealing leaf is/are of a material selected from amongst a polyester, a polyamide, a polyurethane or a polyethylene.

3. The canvas as claimed in claim 1, wherein the polymer material of the said continuous film(s) (220) which constitute a sealing leaf is selected from amongst terephthalate polyethylene or naphthalate polyethylene.

4. The canvas as claimed in claim 1, wherein the said structural fibres (503; 504; 505) are selected from amongst a material chosen from a polyester, a polyamide and an aramid.

5. The canvas as claimed in claim 1, wherein the said structural fibres (503; 504; 505) are non-woven and selected from amongst fibres of polyethylene, carbon, polybenzoxazole, naphthalate polyethylene and terephthalate polyethylene.

6. The canvas as claimed in claim 1, wherein the said structural fibres (503; 504; 505) are multi-filaments.

7. The canvas as claimed in claim 1, wherein the structural fibres (503; 504; 505) of a single layer extend continuously and without overlapping through the surface of the canvas, from one end to another, with orientation which converges radially into one point.

8. The canvas as claimed in claim 7, wherein the structural fibres of two different layers of the said canvas have the same orientation and converge radially into one point.

9. The canvas as claimed in claim 7, wherein the radially converging structural fibres (503, 505) of two different layers (203, 205) of the said canvas converge into two different points.

10. The canvas as claimed in claim 1, wherein at least one of the continuous films (220) of polymer material which constitutes the core (250) of the said canvas has at least one surface which is covered by a layer (220; 240) of fibres (303; 304), known as secondary fibres, the purpose of which is to improve in an isotropic manner mechanical and/or physical properties of the continuous film (220) of polymer material.

11. The canvas as claimed in claim 10, wherein each layer of secondary fibres is assembled by being glued onto a surface of at least one continuous film of polymer material.

12. The canvas as claimed in claim 10, wherein at least one of the layers (240) of secondary fibres is selected from amongst a grid, a taffeta, or a non-woven continuous or discontinuous layer of fibres.

13. The canvas as claimed in claim 10, wherein the secondary fibres (305) of the said layer extend concentrically through the said canvas, around a single central point.

14. The canvas as claimed in claim 13, wherein the secondary fibres (303, 304, 305) with different layers extend concentrically through the said canvas, around two different central points.

15. The canvas as claimed in claim 13, wherein it comprises at least one layer of secondary fibres which extends concentrically around a central point, and at least one layer of structural fibres which extends with an orientation which converges radially into one point, such that the tangents of the arcs of a circle traced by the secondary fibres form angles of approximately 90° with the structural fibres, at the level of the areas of overlapping between structural fibres and secondary fibres.

16. The canvas as claimed in claim 15, wherein the said layer of secondary fibres and the said layer of structural fibres cover a single surface of a continuous film of polymer material; the structural fibres forming the outermost layer.

17. The canvas as claimed in claim 1, wherein the core (250) of the said canvas is formed by a single sealing leaf comprising a single continuous film (220) of polymer material.

18. The canvas as claimed in claim 17, wherein the core (250) of the said canvas is formed by a single sealing leaf constituted by a single continuous film (220) of polymer material, at least one of the surfaces of which is coated by means of counter-gluing with a layer (240) of secondary fibres.

19. The canvas as claimed in claim 1, wherein the core (250) of the said canvas is formed by a single sealing leaf constituted by superimposition of two continuous films of polymer material with a layer of secondary fibres (305) interposed.

20. The canvas as claimed in claim 1, wherein it is covered at least partly on the exterior with a synthetic composition of a paint type with a function of protection of the sails against wear and/or ageing.

21. A sail at least partly produced with at least one piece of a canvas as claimed in claim 1.

22. The sail as claimed in claim 21, wherein at least one piece of canvas which constitutes the said sail has structural fibres (503; 504; 505) of a single layer which extend continuously and without mutual overlapping through the surface of the said piece of canvas, from one end to another, with an orientation which converges radially into one point; the said piece of canvas being disposed in the sail such that these structural fibres (503; 504; 505) are oriented towards at least one point of attachment (103; 104; 105; 106) of the sail.

23. The canvas as claimed in claim 21, characterised in that at least one piece of canvas which constitutes the said sail has secondary fibres (303; 304; 305) of a single layer which extend concentrically through the said piece of canvas, around a single central point; the said piece of canvas being disposed in the sail such that the said central point coincides at least with one point of attachment (103; 104; 105; 106) of the sail.

24. The canvas as claimed in claim 21, wherein at least one piece of canvas which constitutes the said sail comprises at least one layer of secondary fibres (303; 304; 305) which extend concentrically around a central point, and at least one layer of structural fibres (503; 504; 505) which extend with an orientation which converges radially into one point, such that the tangents of the arcs of a circle traced by the secondary fibres (303; 304; 305) form angles of approximately 90° with the structural fibres (503; 504; 505) at the level of the areas of overlapping between structural fibres (503; 504; 505) and secondary fibres (303; 304; 305); the said piece of canvas being disposed in the sail such that the said central point defined by the said secondary fibres (303; 304; 305) and the point of convergence of the said structural fibres (503; 504; 505) coincide at least with one point of attachment (103; 104; 105; 106) of the sail.
